(19) United States
(12) Patent Application Publication
(10) Pub. No.: US 2002/0068617 A1
(43) Pub. Date: Jun. 6, 2002

(54) Hands free apparatus

(76) Inventor: Kim Kyu Han, Seoul (KR)

Correspondence Address: David B. Koo, Esq., Squire, Sanders & Dempsey L.L.P., 14th Floor, 801 S. Figueroa Street, Los Angeles, CA, 90017-5554, US

(21) Appl. No.: 10/011,677

(22) Filed: Dec. 4, 2001

(30) Foreign Application Priority Data
Dec. 2, 2000 (KR) 222457

(51) Int. Cl. H04M 1/00

(52) U.S. Cl. 455/569; 455/568

(57) ABSTRACT

A hands-free device for a mobile phone including an upper casing having a built-in speaker and a lower casing having a magnet to hold the mobile phone is disclosed. The hands-free device includes means for connecting said upper and lower casing to allow the upper casing to rotatably close and open relative to said lower casing, and also includes means for limiting a maximum opening angle of the upper casing. Microphones having a directional input angle of 180 degree or less, which are connected to a same phase signal canceling circuit, are provided to eliminate the incoming background noise.

### BACKGROUND OF THE INVENTION

1. Field of the Invention

This invention relates to a hands-free apparatus, and particularly relates to a hands-free apparatus with an upper casing including a built-in speaker and a lower casing adapted to hold a mobile phone. The hands-free apparatus is designed to allow the upper casing to open up to a maximum angle of about 150° relative to the lower casing.

2. Related Art

Generally, a hands-free apparatus for a mobile phone is installed inside of a car in order to make it convenient for a driver to receive and make calls while driving. A hands-free device usually is adapted to hold or attach the mobile phone, and the voice signals are emitted through a speaker installed on the hands-free device. In order to prevent other people in the car from unnecessarily hearing the conversation, a headphone may be connected to the hands-free device.

However, with conventional hands-free systems, when the mobile phone is placed on the hands-free apparatus, the speaker of the hands-free systems is usually shielded or covered by the mobile phone causing vibration of the voice signals received and transmitted. This makes very difficult or impossible to achieve a high quality conversation, and also requires the hands-free systems to have a higher output capability.

It would therefore be desirable to have a hands-free apparatus that is configured to prevent the speaker of the hands-free apparatus from being shielded or covered by the mobile phone when the mobile phone is placed on the hands-free apparatus.

### BRIEF SUMMARY OF THE INVENTION

This invention relates to a hands-free apparatus, and particularly relates to an apparatus with an upper casing including a built-in speaker and a lower casing adapted to hold a mobile phone in place. The hands-free apparatus is designed to allow the upper casing to open up to a maximum angle of about 150° from the lower casing so that the design of the hands-free apparatus prevents the mobile phone from shielding the built-in speaker. The design of the hands-free device according to the present invention also allows the upper and lower casing to close together completely.

In one embodiment, the hands-free device includes an upper casing with a connecting portion integrally formed and extending from one end of the upper casing, and a lower casing with two connecting parts. The connecting portion of the upper casing is positioned and inserted in the space provided between the two connecting parts of the lower casing, and the inner circumferences of the connecting portion are inserted into and fit with bearing grooves located in the connecting parts of the lower casing. Further, two coupling or connecting pin members are configured to be inserted and removably snapped on through the insertion holes of the connecting parts. In addition, the upper casing and lower casing are provided with means for limiting the maximum opening angle of the upper casing.

Finally, two microphones of the hands-free apparatus are positioned on a substantially straight line with input angles of no greater than about 180 degrees, and when a same-phase signal canceling circuit is connected to these microphones, noise reduction may be achieved with over 50% effectiveness.

Other systems, methods, features and advantages of the invention will be or will become apparent to one of skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a perspective view of different parts of a hands-free apparatus according to one embodiment of the present invention;

FIG. 2 is a side perspective view of the hands-free apparatus according to one embodiment of the present invention

FIG. 3 is a top perspective top view of the hands-free apparatus according to one embodiment of the invention;

FIG. 4 is an exemplary view of the hands-free apparatus with a mobile phone attached according to one embodiment of the present invention;

FIG. 5 is another exemplary view of the hands-free apparatus with a mobile phone attached according to one embodiment of the present invention;

FIG. 6 is an electrical circuit diagram of a microphone system for the hands-free apparatus according to one embodiment of the present invention;

### DETAILED DESCRIPTION OF THE PREFERRED EMBODIMENTS

This description is not to be taken in a limiting sense, but is made for the purpose of illustrating the general principles of the invention. The section titles and overall organization of the present detailed description are for the purpose of convenience only and are not intended to limit the present invention.

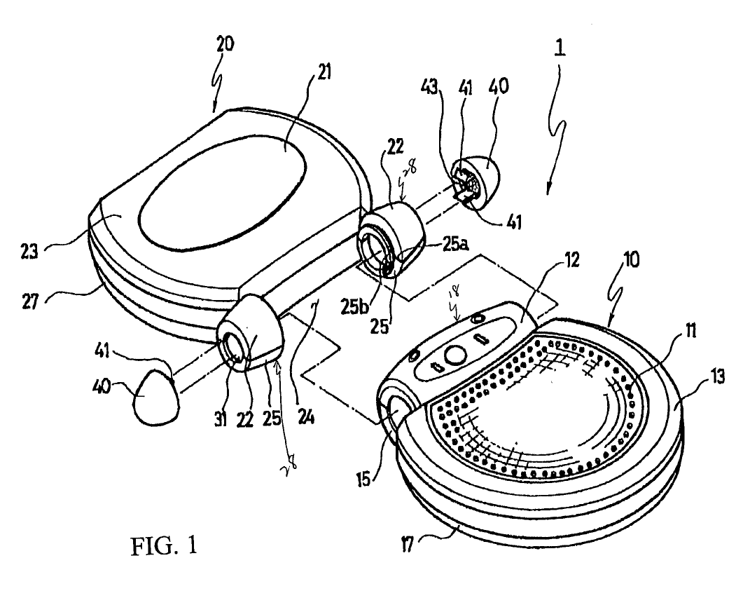

FIG. 1 shows different parts of a hands-free apparatus 1 according to one embodiment of the present invention. As shown in FIG. 1, the hands-free apparatus 1 mainly comprises an upper casing 10 and a lower casing 20.

The upper casing 10 includes a first sub-member 13 and a second sub-member 17. The first and second sub-members 13, 17 are assembled to face each other and form the upper casing 10 as shown in FIG. 1. The first sub-member 13 is generally in the form of concentric circles or a semi-circle, and has a built-in speaker 11 on one side thereof. The second sub-member 17 is preferably provided with an earphone jack. Extending from and integrally formed with at one end of the first sub-member 13 is a first connecting member 12 which generally has a cylindrical shape. The second sub-member is provided with various hands-free switches and other elements.

Similarly, extending from and integrally formed with at one end of the second sub-member 17 of the upper casing 10 is a second connecting member 15, which is adapted to face the first connecting member 12. The first and second connecting members 12, 15 are assembled together to form a connecting portion 18 of the upper casing 10.

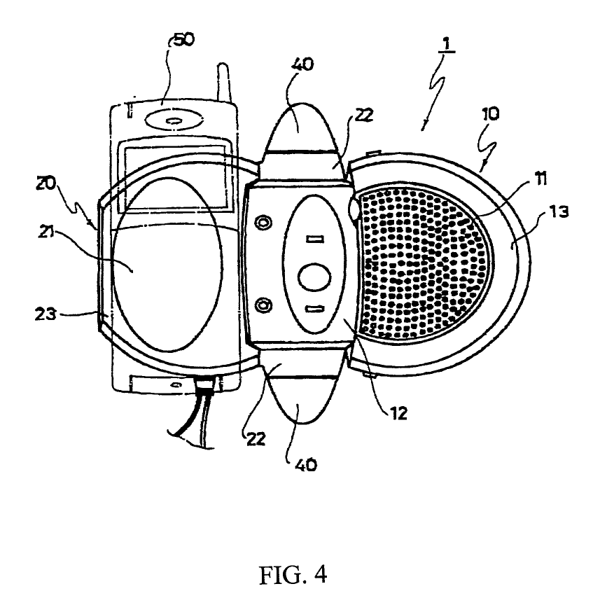

The lower casing 20 also includes a first sub-member 23 and a second-sub-member 27. The first and second sub-members 23, 27 are assembled to face each other and form the lower casing 20. The first sub-member 23 includes a magnet 21 for positioning a mobile phone 50 (FIG. 4) on one side. Extending from and integrally formed with at one end of the first sub-member 23 is two first connecting members 22 as shown in FIG. 1. The two first connecting members 22 generally have a circular shape.

Similarly, extending from and integrally formed with at one end of the second sub-member 27 of the lower casing 20 are two second connecting members 25, which are adapted to face the two first connecting members 22. Each of the first and second connecting members 22 and 25 are assembled together to form the connecting part 28 of the lower casing 20, and there is a space 24 between the two connecting parts 28 as shown in FIG. 1. Further, each of the two connecting parts 28 of the lower casing 20 includes a bearing groove 25b and a locking or hanging chin 25a therein.

So, the connecting portion 18 of the upper casing 10 is inserted in the space 24 between the connecting parts 28 of the lower casing 20 and the inner circumferences of the connecting portion 18 of the upper casing 10 are inserted into and fit with the bearing grooves 25b of the connecting parts 28 of the lower casing 20 in such a manner as to allow rotation of the inner circumferences, thereby allowing the upper casing 10 to open or fold onto the lower casing 20.

Further, on both sides of the connecting parts 28 of the lower casing 20, an insertion hole 31 is formed, which is generally circular in shape. Each of two coupling or connecting pin members 40 is configured to be inserted and removably snapped on through the insertion holes 31 of the connecting parts 28. The connecting pin members 40 each have an integrally formed locking hook 41 which is elastically inserted into the hole 31 of the connecting parts 28 of the lower casing 20, and also a fragrant substance 43 may be placed therein. The connecting pin members 40 are preferably made of a soft material to allow easy insertion into the hole 31 of the connecting parts 28.

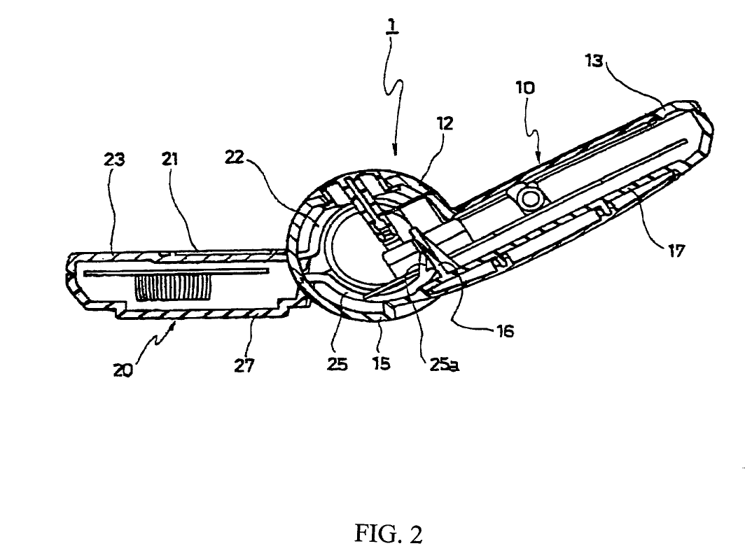

FIG. 2 shows the assembled hands-free apparatus 1 according to one embodiment of the present invention. Particularly, FIG. 2 shows the hands-free apparatus 1 in an open position in which the upper casing 10 and the low casing 20 form an opening angle relative to each other. The connecting members 12 and 15 of the upper casing 10 and the connecting members 22 and 25 of the lower casing 20 are configured to be coupled together so that they allow the upper casing 10 to open or close relative to the lower casing 20. In addition, the upper casing 10 and lower casing 20 are provided with means for limiting the maximum opening angle of the upper casing 10.

The angle limiting means comprises reinforcing ribs 16 provided on both sides of the second sub-member 17 of the upper casing 10, and the hanging chins 25a provided in the second connecting member 25 of the lower casing 20. When the upper casing 10 is opened outwardly, the reinforcing ribs 16 of the second sub-member 17 of the upper casing 10 are blocked by the hanging chins 25a of the lower casing 20, and prevents the upper casing 10 from opening any further. In one embodiment, the maximum opening angle of the upper casing 10 relative to the lower casing 20 is approximately 150 degrees. However, this maximum opening angle can be adjusted by way of modification of the angle limiting structures.

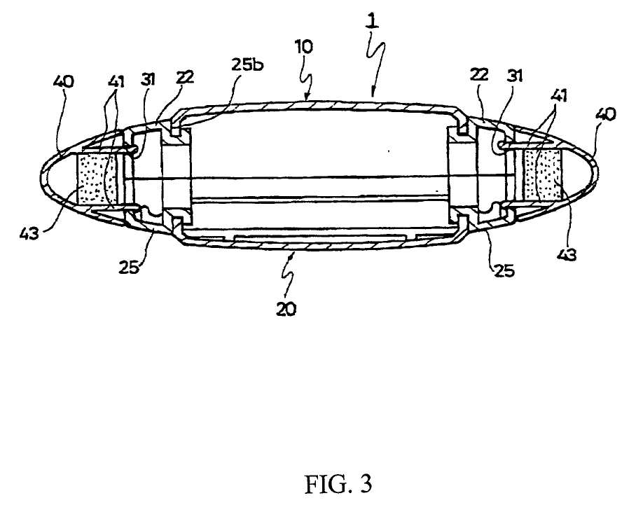

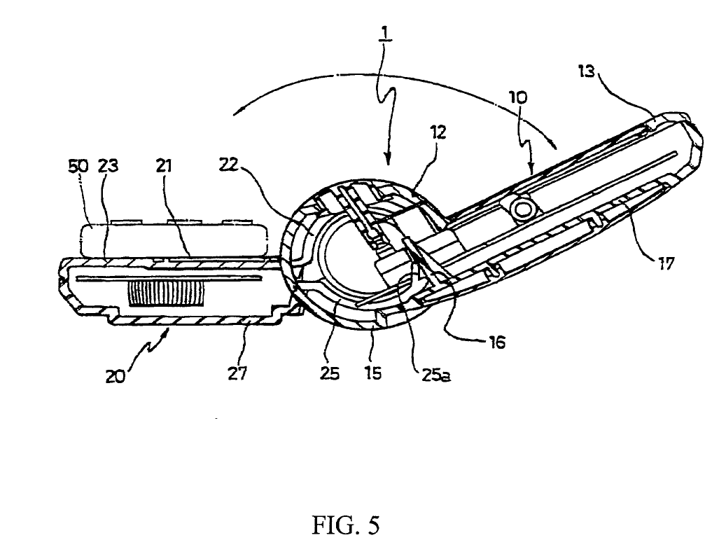

As further illustrated in FIGS. 2-5, to assemble the hands-free apparatus 1 of the present invention, the first and second sub-members 13 and 17 of the upper casing 10 are brought together. At the same time, the first and second connecting members 12 and 15, which are preferably generally cylindrical or semi-circular in shape, are provided at one end of the first and second sub-members 13 and 17, and are assembled so as to form the connecting portion 18 of the upper casing 10, which is generally circular or cylindrical in shape.

Next, the first and second sub-members 23 and 27 of the lower casing 20 are brought together. At the same time, the first and second connecting members 22 and 25 of the lower casing 20, which are integrally formed at one end of the first and second sub-members 23, 27, are also brought together to form the two connecting parts 28, providing the space 24 between the connecting parts 28.

The connecting portion 18 of the upper casing 10 is then positioned and inserted into the space 24 between the connecting parts 28 of the lower casing 20. As the connecting portion 18 of the upper casing 10 is inserted into the pace 24 between the connecting parts 18 of the lower casing 20, the inner circumferences at both ends of the connecting portion 18 of the upper casing 10 are inserted into the bearing grooves 25b of the connecting part 18 so that the inner circumference of the connecting portion 18 interlock with the bearing grooves 25b of the lower casing 20.

Once the hands-free apparatus 1 is properly assembled as described above and illustrated in FIGS. 2-6, it is placed in an appropriate area in a car, preferably around the driver seat area, and the upper casing 10 is opened upwards. At this time, the upper casing 10 may open by having both of the inner circumferences of the connecting portion 18 of the upper casing 10 rotate along the bearing groove 25b of the connecting parts 28 of the lower casing 20.

As the upper casing 10 is being opened, the reinforcing ribs 16 which protrude on both sides of the second sub-member 17 of the upper casing 10 are blocked by the hanging chins 25a which are located and protrude on both sides of the second integral sub-member 25 of the lower casing 20. The reinforcing ribs 16 together with the hanging chins 25a are configured to prevent the upper casing 10 from opening any further. The angle to which the upper casing 10 can unfold from the lower casing 20 is limited so as to maintain a maximum opening angle, preferably about 150 degrees.

The mobile phone 50 is placed on the surface of the first sub-member 23 of the lower casing 20, which includes the magnet 21. The mobile phone 50 is then used to send and receive calls. The voice signal received or transmitted is output through the speaker 11, which is built into the first sub-member 13 of the upper casing 10, and is heard by the driver and the passengers. The upper casing 10 may unfold from the lower casing 20 to a desired opening angle up to a maximum of about 150 degrees so as to ensure that the speaker 11 on the upper casing 10 is not blocked by the mobile phone 50 placed on the lower casing 20, thereby obtaining high-quality voice signals.

When one has finished using the hands-free apparatus 1, the upper casing 10 may fold onto the lower casing 20, and be stored allowing more efficient use of the space within the car.

Furthermore, as described above, the connecting pin members 40 are inserted on both sides at the inner circumference of the connecting parts 28 of the lower casing 20 in such a manner as to allow elastic attachment and detachment by means of the locking hooks 41 formed inside the connecting pin members 40. Also, since the connecting pin members 40 may be preferably made of soft material, it is easy to grasp them, and it is also easy to assemble and disassemble the hands-free device.

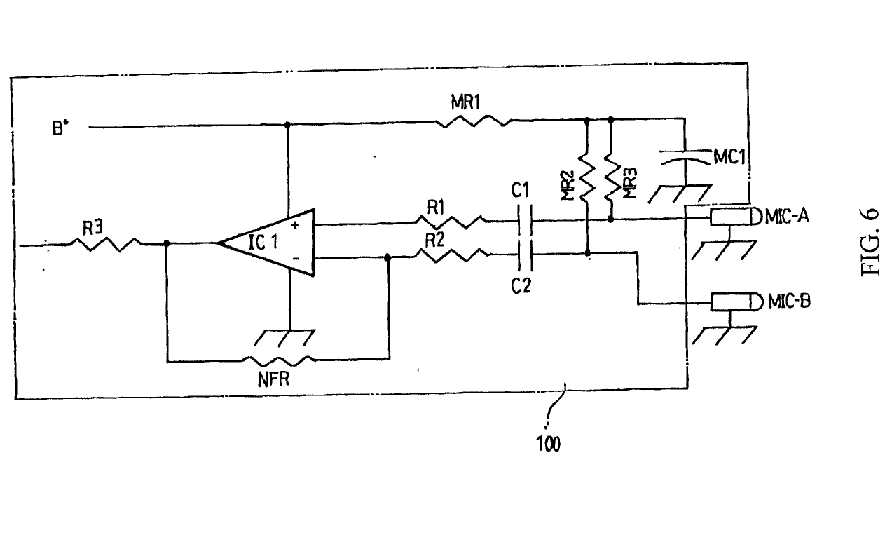

FIG. 6 shows an electrical circuit diagram of a microphone system for the hands-free apparatus 1 according to another embodiment of the present invention. The microphone system is configured to be connected to the hands-free apparatus 1 and may be placed in an appropriate place within the car and preferably in front of a user. FIG. 6 illustrates by way of example two microphones, and the input angles reflecting the pickup topology for each microphone are no greater than 180 degrees.

As illustrated in FIG. 6, a resistor (R1) and a noise canceling capacitor (C1) are serially connected to the non-inverting terminal (+) of a differential amplifier (IC1) with predetermined operating parameters. Another resistor (R2) and noise canceling capacitor (C2) are serially connected to the inverting terminal (−) of the differential amplifier (IC1). The other ends of capacitors (C1) and (C2) are connected to a first directional microphone (MC-A) and a second directional microphone (MC-B). The microphones have a directional signal input angle of no greater than 180 degrees, and the biases of the first and second microphones (MC-A) and (MC-B) are controlled by resistors (MR1), (MR2) and (MR3). Power supply B+is applied to resistors (MR1), (MR2) and (MR3), which are connected in parallel between the capacitors (C1) and (C2) and the first and second microphones (MC-A) and (MC-B). An NFR resistor is connected across the output terminal and the inverting terminal (−) of the differential amplifier (IC1) to adjust signal amplitude; thereby constituting a same-phase signal canceling circuit 100.

The incoming signal conditions for the two signals coming from the first and second microphones respectively are identical as a result of the equivalence of the time constants for the two signals. The time constants are caused to be identical by means of the resistors (R1) and (R2) and capacitors (C1) and (C2), at the inverting terminal (−) input and the non-inverting terminal (+) input of the differential amplifier (IC1).

Also, the first and second microphones (MC-A) and (MC-B) are caused to have a directional input angle of 180 degrees or less, and positioned on a substantially straight line in front of a user. This arrangement will result in a slight time delay in the received signals of the first and second microphones and ensures that the phases of main voice signal received are not identical.

In other words, the voice signal generated through the first and second microphones (MC-A) and (MC-B) is output in sync with the B+power supply via bias-control resistors (MR1), (MR2) and (MR3). This output is applied to the inverting terminal (−) input and the non-inverting terminal (+) input of the differential amplifier (IC1) under identical signal conditions as a result of establishing identical values for the time constants by means of the resistors (R1) and (R2), and the capacitors (C1) and (C2).

At this time, the time lag between the main voices arriving via the first and second microphones (MC-A) and (MC-B) is so short that it cannot be perceived by the human ear. Since the directional angle of the input signal is no greater than 180 degrees, and the microphones are placed in a substantially straight line in front of the user, the main voices do not have identical phases due to this time lag between the input signals from the first and second microphones (MC-A) and (MC-B).

Consequently, from among the signals applied to the inverting input terminal (−) and non-inverting input terminal (+) of the differential amplifier (IC1), background noise having electrically identical signal phases in the same timeframe are eliminated at the differential amplifier (IC1). The main voices, however, which do not have the same phases, are not eliminated but rather output with amplification.

Thus, when a same-phase signal canceling circuit (100) is connected to microphones of the hands-free apparatus (1) as described above, no less than 50% of the incoming background noise other than the main voice can be eliminated.

Having thus described different embodiments of the invention, other variations and embodiments that do not depart from the spirit of the invention will become readily apparent to those skilled in the art. The scope of the present invention is thus not limited to any one particular embodiment, but is instead set forth in the appended claims and the legal equivalents thereof.

What is claimed is:

1. A hands-free device for a mobile phone comprising:
an upper casing having a built-in speaker and a connecting portion integrally formed with and extending from one end of said upper casing;
a lower casing including a magnet and two connecting parts integrally formed with and extending from one end of said lower casing;
wherein said connecting portion and said connecting parts are coupled together to connect said upper and lower casings, and wherein said upper casing is adapted to fold and open to a maximum opening angle relative to said lower casing.

2. A hands-free device of claim 1, further comprising means for limiting said maximum opening angle.

3. A hands-free device of claim 2, said means for limiting said maximum opening angle comprises reinforcing ribs located on said upper casing and hanging chins located on said lower casing, wherein said hanging chins block said reinforcing ribs as said upper casing opens from said lower casing.

4. A hands-free device of claim 1, wherein said connecting portion is positioned in a space formed between said connecting parts, and wherein inner circumferences of said connecting portion fit with bearing grooves of said connecting parts.

5. A hands-free device of claim 1, wherein said magnet holds said mobile phone.

6. A hands-free device of claim 1, wherein said maximum angle is about 150 degrees.

7. A hands-free device of claim 1, further comprising:
a microphone system having at least two microphones, wherein said microphones are configured to have a directional input angle of 180 degrees or less; and
a same phase signal canceling circuit, said canceling circuit connected to said microphones.

8. A hands-free device of claim 7, wherein said microphone system is adapted to be placed on a substantially straight line in front of a user.

9. A hands-free device of claim 1, further comprising connecting pin members having locking hooks, said connecting pin members adapted to elastically attach and detach to said connecting parts of said lower casing.

10. A hands-free device for a mobile phone comprising:
an upper casing having a built-in speaker;
a lower casing having a magnet, wherein said magnet holds said mobile phone;
means for connecting said upper and lower casing, wherein said connecting means allows said upper casing to rotatably close and open to a maximum opening angle relative to said lower casing;
means for limiting said maximum opening angle; and
at least two microphones having a directional input angle of 180 degree or less, wherein said microphones are connected to a same phase signal canceling circuit.

11. A hands-free device of claim 10, wherein said maximum opening angle is about 150 degrees.
